(19) United States
(12) Patent Application Publication
(10) Pub. No.: US 2003/0117531 A1
(43) Pub. Date: Jun. 26, 2003

(54) Mobile karaoke system

(76) Inventors: Yakov Shoel-Berovich Rovner, Ostrovtsy (RU); Marina Alekseevna Agadzhanova, Moscow (RU)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/296,182

(22) PCT Filed: Feb. 5, 2002
(86) PCT No.: PCT/RU02/00036

(30) Foreign Application Priority Data
Mar. 28, 2001 (RU) 2001108223

(51) Int. Cl. H04N 5/44

(52) U.S. Cl. 348/729; 348/553

(57) ABSTRACT

The present invention refers to musical television systems. The transmitting device comprises an audio signals control processor, a video signals control processor, a voice signals processor, permanent memory devices for data storage of musical accompaniment and background images, cartridges with musical accompaniment and background images, a matrix of switches, a liquid crystal display, an audio card, internal and external microphones, a mixer; a modulated high-frequency radio signals generator and a low-frequency television signals generator. Television receivers are capable of reception of the modulated high-frequency radio signals at an aerial input, and of low-frequency television signals at a video input. The system possesses the expanded functional characteristics. In case of reception of television signals at a video input, the absence of the nonlinear high-frequency converters causing essential distortions of initial signals predetermines the increased quality of reproduction of voice parties with background images.

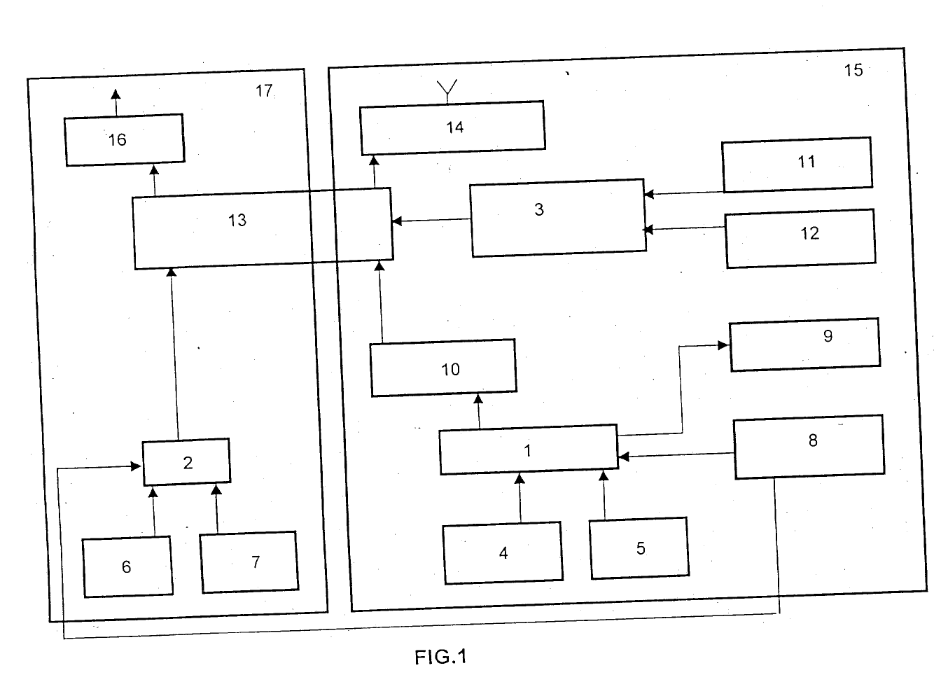

The invention refers to a karaoke system capable of both wire and wireless transmission of video and audio signals to television receivers.

The modern device for the musical accompaniment, usually named karaoke system, is designed so as to reproduce lyrics of the song sung by a singer or a woman-singer before a microphone by means of an electronic audio system together with the downloaded musical accompaniment. The usual karaoke system includes a player on a magnetic tape or disks for reproduction of musical accompaniment of songs.

The user can experience pleasure in singing the chosen song while mixing his voice through a microphone with reproduced musical accompaniment. Karaoke systems become popular in between many people who wish to sing songs to accompaniment of the chosen music for perfection of their performing qualities.

The typical karaoke system used in many restaurants and bars includes a microphone, a broadband stereo system with the powerful amplifier, which allows mixing of sounds, an echo generator for improvement of quality of a sound of a voice of the performer, a separate control device providing the singer or the woman-singer a chance to have a choice of songs and synchronization with them, to alter a degree of amplification of a microphone and music, tempo and pitch of a sound from the place where he or she stands, and gives wide enough choice of melodies. In such a system the microphone and the control device send signals through wire communication channel to a stereo system which reproduces the chosen accompanying melody mixed with a voice of the singer processed in an appropriate way by a stereo system.

The other desirable area of use of the karaoke system is up to requirements of many young people to have a choice of songs and alter a volume of a sound at driving a motor-car.

There is an opportunity of connection of necessary components of typical karaoke system to a car stereo system.

At last, a design of karaoke system for domestic use is also possible.

In any case, karaoke systems in combination with television receivers for final reproduction are perspective.

There are known karaoke systems comprising complete sets for audio and video transformation, and also the transmitters and receivers providing for performance of a vocal party to musical accompaniment, transmission and reception of the high-frequency modulated radio signals, with the help of a network of a cable television included, to an aerial input of the television receiver and reproduction of a vocal party with a background image (JP 6215547, G 11 B 31/00, 05.08.1994, JP 6202677, G 10 K 15/04, 22.07.1994; JP 11007288, G 10 K 15/04, 12.01.1999; JP 11007289, G 10 K 15/04, 12.01.1999). Some karaoke systems are equipped with television monitors for display of lyrics of songs so that the singer could read lyrics during performance (U.S. Pat. No. 5,654,516, G 10 H 7/00, 05.08.1997).

The drawbacks of the known systems are predefined by essential complexity and poor quality of reproduction of vocal parties and background images which are caused by a great number of intermediate transformations.

Similar karaoke systems, in which transmission and reception of the low-frequency modulated signals are realized with the help of wire communication channel to a video input of the television receiver, are also known (U.S. Pat. No. 5,473,106 A, G 09 B 15/02, 05.12.1995; U.S. Pat. No. 5,496,178, G 10 H 1/36, 05.03.1996).

However, the area of practical application of the known systems is rather limited because of difficulties of laying wiring in remote premises.

As the closest prototype to the offered one, it is possible to accept portable karaoke system comprising the portable transmitting device integrating an audio signals control processor, the first input of which is connected to a permanent memory (READ-ONLY STORAGE) for a musical accompaniment data storage and corresponding numbers as the digital signals, the second input—to a matrix of switches, and the first output—to an input of the liquid crystal display, a voice signals processor connected with an internal and external microphones, a mixer, the first input of which is connected to an output of the audio signals control processor through an audio card, the second input is connected to an output of the voice signals processor, and the first output—to one of inputs of a modulated high-frequency radio signals generator connected to an aerial, a video signals control processor, the first input of which is connected to the READ-ONLY STORAGE for storage of background images and corresponding numbers as the digital signals, the second input—to a matrix of switches, and an output—to the other input of the modulated high-frequency radio signals generator, the television receivers capable of reception of modulated high-frequency radio signals generated in the transmitting device at the aerial input (U.S. Pat. No. 5,684,261 A, G 10 H 1/36, 04.11.1997).

The drawback of the specified system lies in the presence of distortions of audiovisual signals in television receivers owing to use of exceptionally aerial inputs of television receivers for reception of signals.

The object of the present invention is creation of karaoke system with the expanded functional characteristics, i.e. accompaniment of reproduction of vocal parties and background images in both nearby and remote premises while preserving the high quality of reproduction in the first case.

The object in view is achieved by that in portable karaoke system comprising the portable transmitting device integrating the audio signals control processor, the first input of which is connected to a permanent memory for storage of musical accompaniment data and corresponding numbers as digital signals, the second input—to a matrix of switches, and the first output—to an input of the liquid crystal display, a video signals control processor, the first input of which is connected to a permanent memory for storage of background images and corresponding numbers as digital signals, and the second input—to a matrix of switches, a voice signals processor connected with an internal and external microphones, and the mixer, the first input of which is connected to an output of the audio signals processor through an audio card, the second input is connected to an output of the voice signals processor, and the first output—to an input of the modulated high-frequency radio signals generator connected to the aerial, the television receivers capable of reception of modulated high-frequency radio signals generated in the transmitting device at the aerial input, a low-frequency television signals generator is setup in transmitter, at that the third input of a mixer is connected to an output of the video signals control processor, and the second output—with an input of the low-frequency television signals generator, output of which through a cable is connected to video inputs, at least, a part of television receivers.

The individual essential features of the invention promote achievement of the object in view.

The portable transmitting device has the case adapted for convenient grasp, operation and control by the singer, inside which or on which all fixed compound units of the transmitting device are placed.

Cartridges with musical accompaniment and cartridges with the background images are fixed into transmitting device, wherein are installed into separate slots to be able to connect to the third inputs of the audio signals control processor and the video signals control processor accordingly.

Cartridges are legally authorized and protected from the non-authorized access by the authorized identifying and coding key device with the access password, at that interconnected and connected with a cartridge interface socket microcircuits for storage of the downloaded data of musical accompaniment or background images are fixed in each cartridge and the authorized identifying and coding key device with the access password for prevention of the non-authorized access to the data stored in the READ-ONLY STORAGE of a cartridge and for identification of belonging of a cartridge to a certain set.

The voice signals processor is made and programmed to be able to adjust a pitch of tone, a rhythm, tempo, and delay of a sound, a level of an echo, artificial reverberation and loudness of performance.

The drawing shows the functional system of the offered portable karaoke system.

The portable transmitting device comprises the audio signals control processor 1, the video signals control processor 2, the voice signals processor 3, the READ-ONLY STORAGE 4 for a data storage of musical accompaniment and corresponding numbers as digital signals, the cartridges with musical accompaniment 5, the READ-ONLY STORAGE 6 for storage of background images and corresponding numbers as digital signals, cartridges with background images 7, the matrix of switches (a type-setting field) 8, the liquid crystal display (the display panel) 9, the audio card (the controller of an audio stereo signal) 10, the internal microphone 11, the external microphone 12, the mixer 13, the modulated high-frequency radio signals generator 14 with the aerial 15, the low-frequency television signals generator 16 with an output cable 17.

Television receivers are not shown herein with the purpose of simplification of the drawing.

The first input of the audio signals control processor 1 is connected to the READ-ONLY STORAGE 4 for data storage of musical accompaniment and corresponding numbers as the digital signals, the second input—to a matrix of switches 8, and the first output—to the input of the liquid crystal display 9. The first input of the video signals control processor 2 is connected to the READ-ONLY STORAGE 6 for storage of background images and corresponding numbers as digital signals, and the second input—to a matrix of switches 8. The voice signals processor 3 is connected to the internal microphone 11 and the external microphone 12. The first input of the mixer 13 through the audio card 10 is connected to an output of the audio signals control processor 1, the second input is connected to an output of the voice signals processor 3, the third input—to an output of the video signals control processor 2, the first output—to an input of the modulated high-frequency radio signals generator 14, and the second output—to an input of the low-frequency television signals generator 16. Cartridges with musical accompaniment 5 are fixed and connected to the third input of the audio signals control processor 1. Cartridges with background images 7 are fixed and connected to the third input of the video signals control processor 2.

The portable transmitting device has the case adapted for convenient grasp, operation and control of the singer, inside which or on which all fixed compound units of the transmitting device are placed, and also slots for installation of cartridges 5 and 7 with musical accompaniment and background images.

Cartridges 5 and 7 are legally authorized and protected from the non-authorized access by the authorized identifying and coding key device with the password of access, at that interconnected and connected with a cartridge interface socket READ-ONLY STORAGE microcircuits for storage of the downloaded data of musical accompaniment or background images are fixed in each cartridge and the authorized identifying and coding key device with the access password for prevention of the non-authorized access to the data stored in the READ-ONLY STORAGE of a cartridge and for identification of belonging of a cartridge to a certain set.

The voice signals processor 3 is made and programmed to be able to adjust a pitch of tone, a rhythm, tempo, and delay of a sound, a level of an echo, artificial reverberation and loudness of performance.

Television receivers are capable of reception at the aerial input of the modulated high-frequency radio signals generated in the transmitting device and radiated by the aerial 15. The output of the low-frequency television signals generator 16 is connected to video inputs of, at least, a part of television receivers by means of the cable 17.

During operation of the offered portable karaoke system user can make a choice of preferable musical accompaniment with the help of the matrix of switches 8 from the READ-ONLY STORAGE 4 or the cartridge 5 for performance of musical composition.

The processor 1 controls in general the audio part of the system according to the program stored in its internal memory. The program outputs the musical data corresponding to the chosen number, to the static random access memory. The processor 1 also controls an output of the musical data from the READ-ONLY STORAGE 4 or the cartridge 5. Besides, the processor 1 shows the information on a functional condition of the system on the liquid crystal display 9, and also provides for transmission of the reproduced signals of musical accompaniment to the audio card 10.

The audio signal, i.e. a voice of the singer, is amplified and then with the help of the processor 3 processed for reshaping, setting rhythm and tempo, and also for sorting tone of a high or low level. Moreover, the voice signal is mixed up with an echo—signal (from echo generator). At last, the processor 3 establishes the required delay of a sound, artificial reverberation and volume of performance.

With the help of the matrix of switches 8 from the READ-ONLY STORAGE 6 or cartridge 7 user can also make a choice of the preferable background image for performance of a musical composition.

The processor 2 carries out the general control over the video part of a system according to the program stored in its internal memory. The program delivers the background images corresponding to chosen number to the static random assess memory. The processor 3 also controls the output of background images from the READ-ONLY STORAGE 6 or cartridge 7 and their further transmission.

The mixer 13 mixes a sound of the human voice, the chosen musical accompaniment and the chosen background images.

In the present karaoke system two generators 14 and 16 are installed at the same time on the outputs of the mixer 13 providing for generation of the modulated signals with different ranges of working frequencies.

The generator 14 generates and transmits to the aerial 15 modulated high-frequency radio signals in a range 60-130 MHz, which are outputted to the aerial inputs of television receivers. The generator 16 modulates and transmits to the cable 17 low-frequency signals in a range of 50 Hz-7 MHz, which are outputted to the video inputs of television receivers.

Thus the offered karaoke system has the expanded set of functional characteristics, namely performance of a vocal party to musical accompaniment with the background image is provided for while use both aerial inputs and video inputs of television receivers, the latter, as known, do not provide for installation of the nonlinear high-frequency converters in a transmission channel causing essential distortions of initial signals. In this connection user should better use the video inputs providing increased quality of reproduction of vocal parties with background images at television receivers placed in premises nearby from the singer.

1. Portable system karaoke comprising a portable transmitting device further integrating the audio signals control processor, the first input of which is connected to a constant memory for a data storage of musical accompaniment and corresponding numbers as the digital signals, second input—to a matrix of switches, and the first output—to an input of the liquid crystal display, a video signals control processor, the first input of which is connected to a permanent memory for storage of background images and corresponding numbers as digital signals, and the second input—to a matrix of switches, a voice signals processor connected with internal and external microphones, and a mixer, the first input of which through an audio card is connected to an output of the audio signals control processor, the second input is connected to an output of the voice signals processor, and the first output—to an input of the modulated high-frequency radio signals generator connected to an aerial, television receivers capable of reception of modulated high-frequency radio signals generated in the transmitting device at the aerial input, distinguished by that the low-frequency television signals generator is installed into the transmitting device, at that the third input of a mixer is connected to an output of the video signals control processor, and the second output—with an input of the low-frequency television signals generator, the output of which is connected to video inputs of, at least, a part of television receivers by means of a cable.

2. A system according to claim 1, distinguished by that the portable transmitting device is encased into embodiment adapted for convenient grasp, operation and control by the singer inside which or on which all fixed compound units of the transmitting device are placed.

3. A system according to claims 1 or 2, distinguished by that cartridges with musical accompaniment and cartridges with the background images are installed into the transmitting device, the said cartridges being placed into separate slots to be capable of connection to the third inputs of the audio signals control processor and the video signals control processor accordingly.

4. A system according to claim 3, distinguished by that cartridges are legally authorized and protected from the non-authorized access by the authorized identifying and coding key device with the password of access, at that interconnected and connected with a cartridge interface socket microcircuits for storage of the downloaded data of musical accompaniment or background images are fixed in each cartridge and the authorized identifying and coding key device with the access password for prevention of the non-authorized access to the data stored in the READ-ONLY STORAGE of a cartridge and for identification of belonging of a cartridge to a certain set.

5. A system according to claim 1 or 2, distinguished by that the voice signals control processor is made and programmed to be capable of adjustment of height of tone, a rhythm, tempo, a delay of a sound, a level of an echo, artificial reverberation and volume of performance.
